(19) United States
(12) Patent Application Publication
(10) Pub. No.: US 2003/0004738 A1
(43) Pub. Date: Jan. 2, 2003

(54) Systems and methods for screening job applicants

(76) Inventor: Ravi Chandar, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/896,415

(22) Filed: Jun. 28, 2001

(51) Int. Cl. G06F 17/60

(52) U.S. Cl. 705/1

(57) ABSTRACT

Systems for screening an applicant are provided. A representative system includes an applicant evaluation system that is configured to provide an applicant with at least one test question via a Web-site. Such a test question is associated with the job about which the applicant is inquiring. The applicant evaluation system also is configured to enable the applicant to apply for the job if the applicant correctly answers the test question(s). This can be accomplished via the Web-site. Other systems and methods also are provided.

### BACKGROUND OF THE INVENTION

1. Field of the Invention

The present invention generally relates to computers. More specifically, the invention relates to systems and methods that facilitate screening of an applicant who is attempting to apply for a job, for example.

2. Description of the Related Art

Organizations typically advertise job openings via various media. For instance, organizations advertise job openings in newspapers, on television and on Web sites. In response to these advertisements, such an organization may receive a tremendous number of applicant responses. These responses are then reviewed in order to determine whether the applicant possesses the qualifications required for the job opening.

A typical response from an applicant to a job opening advertisement includes a resume describing the applicant's background and qualifications. Unfortunately, information contained on a resume oftentimes does not provide an accurate, practical and/or objective assessment of the applicant's qualifications for a particular job. Therefore, there is a need for improved systems and methods that address these and/or other shortcomings of the prior art.

### SUMMARY OF THE INVENTION

Briefly described, the present invention relates to systems and methods that facilitate screening of an applicant who is attempting to apply for a job. In this regard, a representative method includes receiving information from an applicant corresponding to a particular job and determining whether the applicant is required to take a test prior to applying for that job. The test should be adapted to determine whether the applicant possesses a requisite level of knowledge pertaining to that job. The method also includes enabling the applicant to take the test and determining the applicant's responses to the test. If the responses to the test meet a predetermined standard, the applicant can be permitted to apply for the job.

Since it may be assumed that not all applicants taking the test will meet the predetermined standard, at least on the first attempt, the aforementioned and/or other methods of the invention can advantageously reduce the number of applicants, i.e., those submitting applications, for a particular job. This also can reduce a corresponding workload for those involved with applicant hiring, as applicant information, which may be in the form of resumes, for example, may not be received and/or processed until the applicant meets the predetermined standard.

Another representative method for screening an applicant includes the steps of receiving information, which corresponds to a job, from an applicant via a Web-site. It then can be determined whether the applicant is required to take a test prior to applying for that job. If the applicant is required to take a test, the applicant is provided with a question(s) via the Web-site and is enabled to answer the question(s) via interaction with the Web-site. Once information corresponding to the applicant's answer(s) is received, the applicant is permitted to apply for the job via the Web-site if the applicant's answer(s) is correct.

Other embodiments of the invention can be implemented as systems for screening an applicant. In this regard, an embodiment of the system includes an applicant evaluation system that is configured to provide an applicant with test question(s) via a Web-site. Such a test question is associated with the job about which the applicant is inquiring. The applicant evaluation system also is configured to enable the applicant to apply for the job if the applicant correctly answers the test question(s). This can be accomplished via the Web-site.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram depicting a representative embodiment of the human resources system of the present invention.

FIG. 2 is a flowchart depicting functionality embodiment of the human resources system of FIG. 1.

FIG. 3 is a schematic diagram depicting a computer or processor-based system that can be used to implement of an embodiment of the applicant evaluation system of FIG. 1.

FIG. 4 is a flowchart depicting functionality of an embodiment of the qualifications system of FIG. 3.

FIG. 5 is a flowchart depicting functionality of an embodiment of the testing system of FIG. 3.

FIG. 6 is a flowchart depicting functionality of an embodiment of the resume system of FIG. 3.

### DETAILED DESCRIPTION

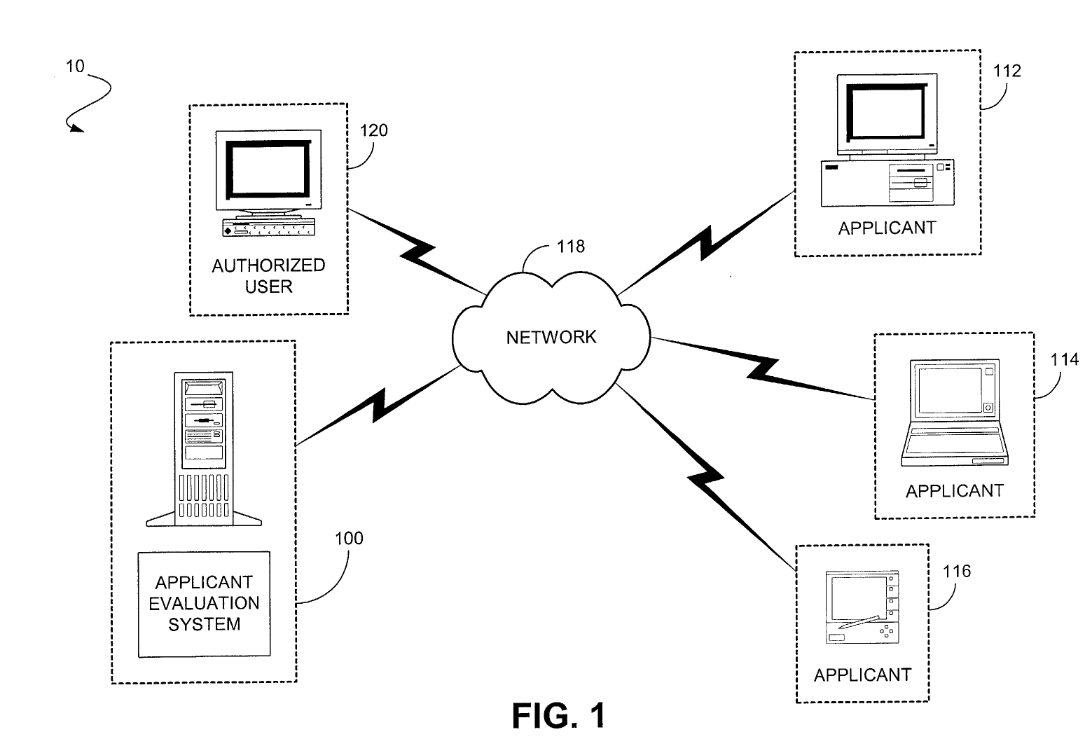

Reference will now be made to the drawings wherein like reference numerals indicate corresponding components throughout the several views. Depicted in FIG. 1 is a representative embodiment of the human resources system 10 of the present invention. As shown in FIG. 1, human resources system 10 includes an applicant evaluation system 100 that is adapted to facilitate screening of applicants for job openings. As described in greater detail hereinafter, applicant evaluation system 100 can acquire objective information from an applicant that is relevant to a job about which the applicant is inquiring. In some embodiments, the applicant evaluation system resides on a server(s) and is implemented, at least in part, by a Web site.

In this regard, various applicants, such as applicants 112, 114 and 116, can communicate with the applicant evaluation system 100 via a communication network 118. Communication of an applicant typically is facilitated by a communication device, such as a personal computer, laptop and/or personal digital assistant, for example. Other entities also may communicate with applicant evaluation system 110 via network 118. By way of example, an authorized user 120 could communicate with the applicant evaluation system, such as by using a workstation. For example, the authorized user could be a hiring manager of the organization that is advertising job openings. In some embodiments, authorized users can modify the applicant evaluation system as described in detail hereinafter.

Communication network 118 may be any type of communication network employing any network topology, transmission medium, or network protocol. For example, network 118 may be a local area network (LAN), a metropolitan area network (MAN), a wide area network (WAN), any public or private packet-switched or other data network, including the Internet, circuit-switched networks, such as the public switched telephone network (PSTN), wireless networks, or any other desired communications infrastructure.

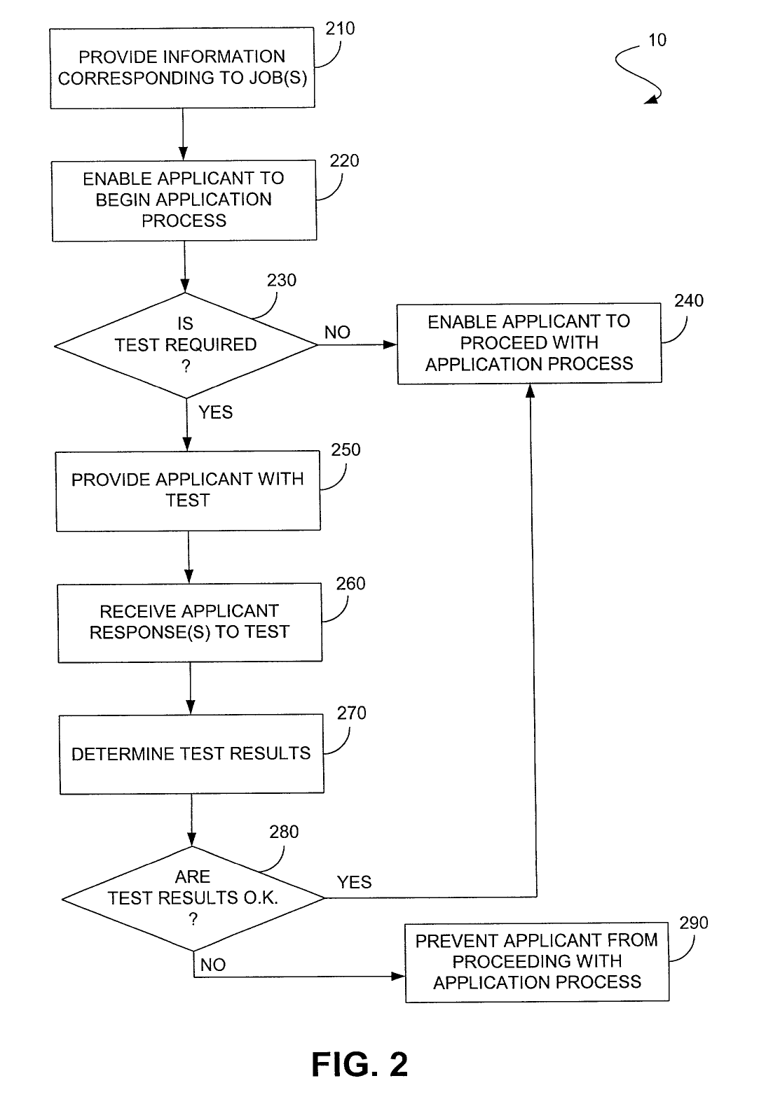

Referring now to the flowchart of FIG. 2, functionality of an embodiment of the human resources system 10 of FIG. 1 will be described in greater detail. It should be noted that, in some alternative implementations, the functions noted in the various blocks of this and/or other flowcharts depicted herein may occur out of the order depicted. For example, two blocks shown in succession in FIG. 2 may be performed concurrently or in an order other than that depicted.

In FIG. 2, human resources system or method 10 may be construed as beginning at block 210 where information corresponding to one or more job openings is provided. By way of example, the information can be posted and made available to an applicant(s) via a Web site. In other embodiments, the information can be provided in various other formats so that an applicant can identify a particular job regarding which the applicant intends to apply. In block 220, the applicant is enabled to initiate an application process associated with the identified job. Thereafter, such as depicted in block 230, a determination is made as to whether the applicant is required to take a test associated with that job. If it is determined that a test is not required, the process may proceed to block 240, where the applicant is enabled to complete the application process for that job. For instance, the applicant may be permitted to submit a resume. If, however, it is determined that a test is required, the process may proceed to block 250 where the applicant is provided with the test. Such a test can include multiple choice and/or other formats of questions that are intended to determine whether the applicant possesses a requisite level of knowledge. Thus, the test could be designed to evaluate fundamental knowledge and/or skills required for a particular job.

In block 260, applicant responses to the test are received. Test results then are determined and an evaluation is conducted to determine whether the test results meet minimum predetermined standards (depicted in blocks 270 and 280, respectively.) If it is determined in block 280 that the test results either meet or exceed the minimum predetermined standards associated with the job, the process may return to block 240 where the applicant is enabled to complete the application process. If, however, the test results do not meet the predetermined standards, the process may proceed to block 290 where the applicant may be prevented from completing the application process for that job. For instance, the applicant may be prevented from submitting a resume.

In some embodiments, the functionality attributable to blocks 220 through 290 of FIG. 2 can be provided by the applicant evaluation system 100 (FIG. 1).

By testing an applicant, objective information pertaining to that applicant can be acquired. The information can then be used to determine whether the applicant possesses the basic knowledge and/or skills that are considered necessary to perform that job and/or to work for the organization. The skills and/or knowledge corresponding to the job can be updated or otherwise modified, in some embodiments, by personnel familiar with that job. Therefore, an applicant with particular skills can be readily identified by human resources systems 10 of the present invention.

Additionally, due to the potentially tremendous number of inquiries and/or applicants for job openings, the aforementioned functionality can be used to limit the number of applicants, and associated applicant resumes, for example, applying for a particular job. Thus, a department that typically is responsible for screening applicants for job openings can permit the human resources system to perform at least some of the applicant screening, thereby potentially reducing the number of applicants.

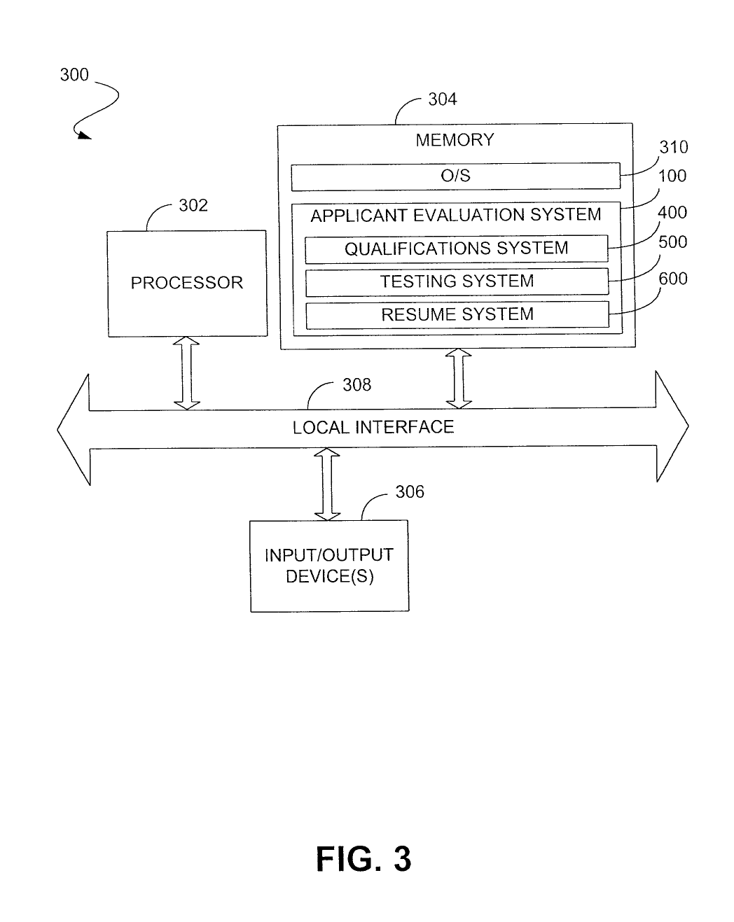

The applicant evaluation system of the present invention can be implemented in software, firmware, hardware, or a combination thereof. In some embodiments, the applicant evaluation system can be implemented in software as an executable program. For example, each control system can be executed by a special or general purpose digital computer, such as a personal computer (PC; IBM-compatible, Apple-compatible, or otherwise), workstation, minicomputer, or mainframe computer. An example of a general purpose computer that can implement the applicant evaluation system is shown schematically in FIG. 3.

Generally, in terms of hardware architecture, computer 300 includes a processor 302, memory 304, and one or more input and/or output (I/O) devices 306 (or peripherals) that are communicatively coupled via a local interface 308. Local interface 308 can be, for example, one or more buses or other wired or wireless connections, as is known in the art. Local interface 308 can include additional elements, which are omitted for ease of description. These additional elements can be controllers, buffers (caches), drivers, repeaters, and/or receivers, for example. Further, the local interface may include address, control, and/or data connections to enable appropriate communications among the components of computer 300.

Processor 302 is a hardware device configured to execute software that can be stored in memory 304. Processor 302 can be any custom made or commercially available processor, a central processing unit (CPU) or an auxiliary processor among several processors associated with the computer 300. Additionally, the processor can be a semiconductor-based microprocessor (in the form of a microchip) or a macroprocessor. Examples of representative commercially available microprocessors are as follows: a PA-RISC series microprocessor from Hewlett-Packard Company, U.S.A., an 80x86 or Pentium series microprocessor from Intel Corporation, U.S.A., a PowerPC microprocessor from IBM, U.S.A., a Sparc microprocessor from Sun Microsystems, Inc, or a 68control series microprocessor from Motorola Corporation, U.S.A.

Memory 304 can include any combination of volatile memory elements (e.g., random access memory (RAM, such as DRAM, SRAM, etc.)) and/or nonvolatile memory elements (e.g., ROM, hard drive, tape, CDROM, etc.). Moreover, memory 304 can incorporate electronic, magnetic, optical, and/or other types of storage media. Note that memory 304 can have a distributed architecture, where various components are situated remote from one another, but can be accessed by processor 302.

The software in memory 304 can include one or more separate programs, each of which comprises an ordered listing of executable instructions for implementing logical functions. In the example of FIG. 3, the software in the memory 304 includes the applicant evaluation system 100 and a suitable operating system (O/S) 310. A nonexhaustive list of examples of commercially available operating systems 310 is as follows: a Windows operating system from Microsoft Corporation, U.S.A., a Netware operating system available from Novell, Inc., U.S.A., or a UNIX operating system, which is available for purchase from many vendors, such as Hewlett-Packard Company, U.S.A., Sun Microsystems, Inc., and AT&T Corporation, U.S.A. The operating system 310 controls the execution of other computer programs, such as the applicant evaluation system 100. Operating system 310 also provides scheduling, input-output control, file and data management, memory management, and communication control and related services.

The I/O device(s) 306 can include input devices, such as communication ports, a keyboard and a mouse, for example. The I/O device(s) 306 also can include output devices, such as communication ports and a display screen, for example. I/O device(s) 306 may further include devices that are configured to communicate both inputs and outputs, such as a modulator/demodulator.

When the computer 300 is in operation, processor 302 is configured to execute software stored within the memory 304, communicate data to and from the memory 304, and generally control operations of the computer 300. The applicant evaluation system 100 and the O/S 310, in whole or in part, are read by the processor 302, perhaps buffered within processor 302, and then executed.

In alternative embodiments, the applicant evaluation system 100 can be implemented in hardware. When implemented in hardware, the applicant evaluation system can be implemented with any or a combination of various technologies. By way of example, the following technologies, which are each well known in the art, can be used: a discrete logic circuit(s) having logic gates for implementing logic functions upon data signals, an application specific integrated circuit (ASIC) having appropriate combinational logic gates, a programmable gate array(s) (PGA), and a field programmable gate array (FPGA).

When the applicant evaluation system 100 is implemented in software, it should be noted that the system can be stored on any computer readable medium for use by or in connection with any computer-related system or method. In the context of this document, a computer-readable medium is an electronic, magnetic, optical, or other physical device or means that can contain or store a computer program for use by or in connection with a computer-related system or method. Applicant evaluation system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

As shown in FIG. 3, the applicant evaluation system 100 can include one or more modules or systems. For example, the applicant evaluation system can include a qualifications system 400, a testing system 500 and a resume system 600. Functionality of an embodiment of each of the aforementioned systems will be described hereinafter.

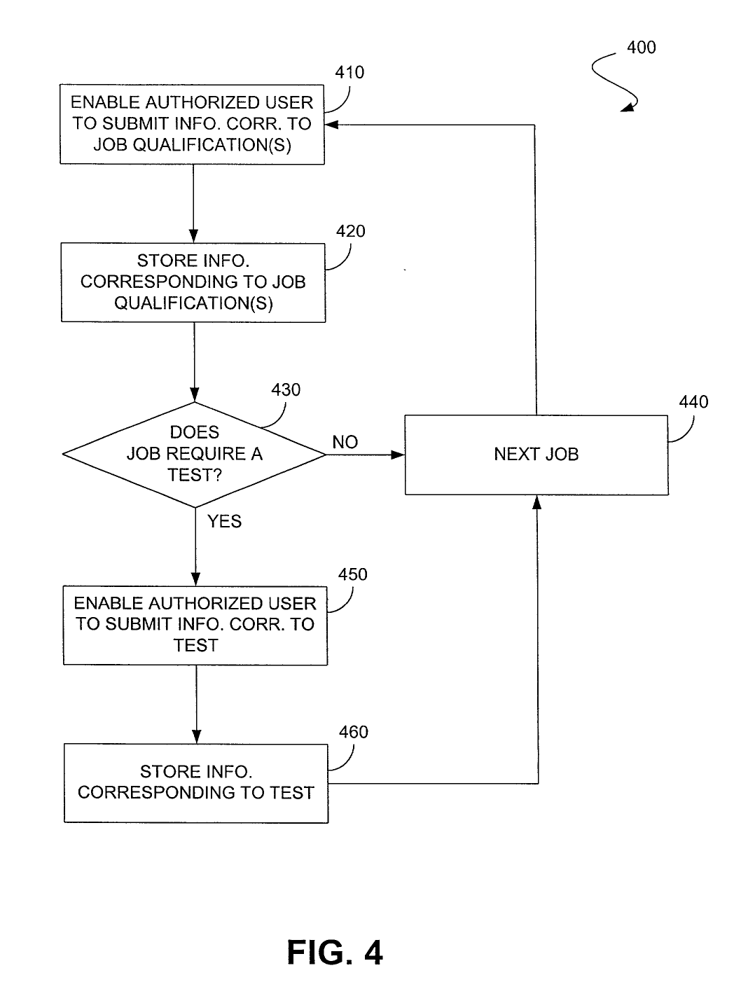

In this regard, functionality of an embodiment of the qualifications system is depicted in FIG. 4. In FIG. 4, the qualifications system or method 400 may be construed as beginning at block 410 where an authorized user is enabled to submit applicant qualifications corresponding to a particular job. By way of example, the authorized user could be one responsible for hiring applicants and/or one familiar with desired qualifications of an applicant for a job. Such qualifications could include educational requirements, experience requirements, etc. In some embodiments, the authorized user can submit the qualifications via a graphical user interface that is provided by the applicant evaluation system. The graphical user interface could prompt the authorized user to provide information corresponding to a particular job as well as qualifications pertaining to that job. Additionally, the graphical user interface could be used to determine whether the user is an authorized user, such as by prompting the user for a password.

Proceeding to block 420, information corresponding to the applicant qualifications desired for the job is stored. In block 430, a determination may be made as to whether an applicant for the job will be required to take a test. If it is determined that such an applicant is not required to take a test, the process may proceed to block 440. As shown in block 440, the authorized user can be prompted for information pertaining to a next job. In this instance, the process may return to block 410 and proceed as described hereinbefore. If, however, it is determined that an applicant for the job is required to take a test, the process may proceed to block 450.

In block 450, an authorized user is enabled to submit information corresponding to a qualifications test. For example, this information may include one or more questions and/or exercises that are to be provided to an applicant. Typically, the questions are provided in the form of multiple choice questions, which can facilitate efficient automated evaluation of applicant answers. The authorized user also provides answers to the submitted questions as well as a recommended time interval during which the applicant is to complete taking the test. In block 460, the information, e.g., the questions and answers, is stored by the qualifications systems. Thereafter, the process may return to block 440 and then proceed as described hereinbefore.

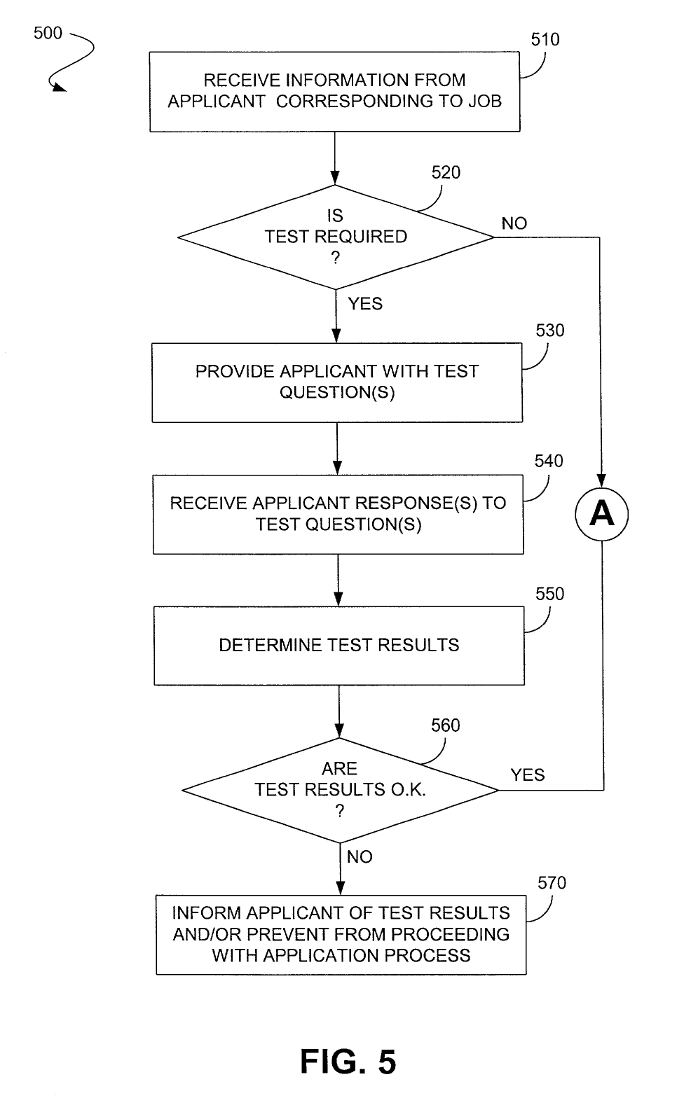

Functionality of a representative embodiment of the testing system 500 will now be described with reference to the flowchart of FIG. 5. In FIG. 5, the testing system or method 500 may be construed as beginning at block 510 where information corresponding to a particular job is received from an applicant. More specifically, the information can pertain to an applicant's interest in applying for that job. As mentioned hereinbefore, information corresponding to one or more jobs can be provided to an applicant via a Web site that describes various job openings. In such an embodiment, the applicant could provide information corresponding to a particular job by selecting a job of interest, e.g., by actuating an icon associated with that job, entering an identifier of that job in a corresponding field of the Web site, etc.

In block 520, a determination is made as to whether the selected job requires the applicant to take a test prior to completing the application process. If it is determined that the applicant is required to take a test, the applicant is provided with one or more test questions (block 530). Thereafter, such as depicted in block 540, answers to the test questions are received. In block 550, answers to the test questions are evaluated and a determination is made as to whether the test results are acceptable (depicted in block 560), i.e., the results equal or exceed the established standards for that job. If it is determined that the results are not acceptable, the process may proceed to block 570 where the applicant can be informed that the results were unacceptable and/or the applicant can be prevented from proceeding further with the application process. If, however, it is determined that the results are acceptable (block 560), or alternatively, that there is not a test associated with that job (block 520), the applicant can be permitted to proceed with the application process for that job. In this regard, the application process may include functionality provided by resume system 500 (FIG. 3).

In some embodiments, the process can prompt an applicant to provide information prior to testing. That information could include the applicant's name or any other information that would permit identifying the applicant. In particular, the information should be adequate to identify the applicant so that a determination may be made as to whether the applicant has previously attempted to apply for a job. In some of these embodiments, that determination could include whether the applicant has previously attempted to apply for the current job of interest. If the applicant has previously applied for a job, previously stored test results associated with that applicant could be provided for review by the applicant and/or a user associated with screening of applicants.

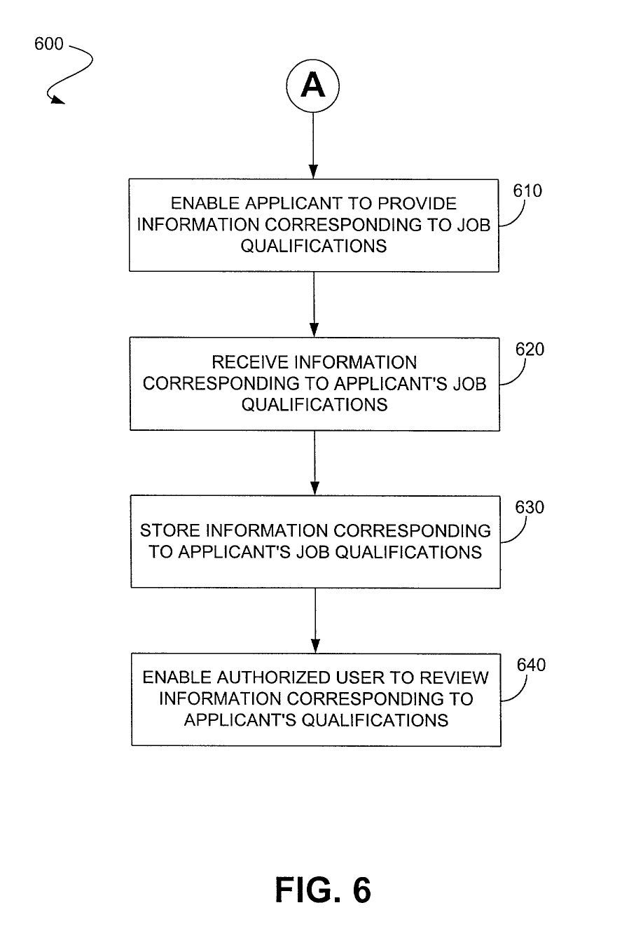

Referring now to FIG. 6, functionality of the representative embodiment of the resume system 600 of FIG. 3 will be described in greater detail. As shown in FIG. 6, resume system or method 600 may be construed as beginning at block 610 where an applicant is enabled to provide information corresponding to the applicant's qualifications. By way of example, this information could include a resume, which may be submitted in electronic form. In block 620, information corresponding to the applicant's qualifications is received. Thereafter, such as depicted in block 630, the information corresponding to the applicant's qualifications can be stored. An authorized user(s) then can be enabled to retrieve the information corresponding to the applicant's qualifications (block 640). The information corresponding to the applicant's qualifications can include that information provided by the applicant as well as information corresponding to one or more tests taken by the applicant.

By using applicant evaluation systems of the present invention, an authorized user can readily obtain information that may be useful in determining whether an applicant should be contacted for more information, interviewed, and/or hired for the job about which the applicant is applying and/or another job. Thus, applicant evaluation systems of the present invention can be an efficient tool for a human resources manager, for example, by providing that manager with subjective information provided by applicants as well as objective information based upon applicant testing.

The foregoing description has been presented for purposes of illustration and description. It is not intended to be exhaustive or to limit the invention to the precise forms disclosed. Modifications or variations are possible in light of the above teachings. The embodiment or embodiments discussed, however, were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

1. A method for screening an applicant, the method comprising the steps of:
receiving information from an applicant corresponding to a job via a Web-site;
determining whether the applicant is required to take a test prior to applying for the job;
providing the applicant with at least one test question, the at least one test question being displayed to the applicant via the Web-site;
enabling the applicant to answer the at least one test question via interaction with the Web-site;
receiving information corresponding to the answer of the applicant; and
enabling the applicant to apply for the job via the Web-site if the applicant's answer to the at least one test question is correct.

2. The method of claim 1, further comprising the step of:
providing the applicant with information corresponding to the job via the Web-site.

3. The method of claim 1, wherein the step of providing the applicant with at least one test question comprises the steps of:
enabling an authorized user to create the at least one test question, the authorized user possessing knowledge associated with the job, the test being adapted to determine whether the applicant possesses knowledge pertaining to the job;
storing the at least one question; and
retrieving the at least one test question based, at least in part, upon the information provided by the applicant corresponding to the job.

4. The method of claim 1, wherein the at least one test question is a multiple choice question including several potential answers, and wherein the step of enabling the applicant to answer the at least one test question comprises the step of:
enabling the applicant to select one of the several potential answers.

5. The method of claim 1, wherein the step of enabling the applicant to apply for the job comprises the steps of:
enabling an authorized user to create the at least one test question, the authorized user possessing knowledge associated with the job;
storing the at least one question;
enabling the authorized user to create an answer to the at least one test question;
storing the answer to the at least one test question;
determining whether the applicant's answer corresponds to the answer to the at least one test question; and
enabling the applicant to submit information if the applicant's answer corresponds to the answer to the at least one test question.

6. The method of claim 1, wherein the step of enabling the applicant to apply for the job comprises the steps of:
preventing the applicant from applying for the job via the Web site if the applicant's answer to the at least one test question is not correct.

7. The method of claim 5, wherein the information is a resume, and wherein the resume is submitted electronically via the Web site.

8. A method for screening an applicant, said method comprising the steps of:
receiving information from an applicant corresponding to a job;
determining whether the applicant is required to take a test prior to applying for the job;
enabling the applicant to take the test;
determining applicant responses to the test; and
enabling the applicant to apply for the job if the responses to the test meet a predetermined standard.

9. The method of claim 8, wherein the step of enabling the applicant to take the test comprises the steps of:
providing the applicant with access to a Web site; and
administering the test via the Web site.

10. The method of claim 8, wherein the step of determining whether the applicant is required to take a test comprises the steps of:
enabling an authorized user to create the test, the authorized user possessing knowledge associated with the job, the test being adapted to determine whether the applicant possesses knowledge pertaining to the job;
storing the test; and
retrieving the test based, at least in part, upon the information provided by the applicant corresponding to the job.

11. The method of claim 8, wherein the test comprises multiple choice questions and the predetermined standard corresponds to a number of the multiple choice questions answered correctly by the applicant.

12. A system for screening an applicant, said system comprising:
an applicant evaluation system configured to provide an applicant with at least one test question via a Web-site, the at least one test question being associated with a job, said applicant evaluation system being further configured to enable the applicant to apply for the job such that, if the applicant correctly answers the at least one test question, said applicant evaluation system enables the applicant to apply for the job via the Web-site.

13. The system of claim 12, wherein said applicant evaluation system is configured to communicate with a communication network.

14. The system of claim 12, wherein said applicant evaluation system includes a qualifications system, said qualifications system being configured to receive information corresponding to predetermined applicant qualifications for the job, said applicant evaluation system being further configured to determine whether the applicant possesses said predetermined applicant qualifications.

15. The system of claim 12, wherein said applicant evaluation system includes:
means for receiving information corresponding to predetermined applicant qualifications for the job; and
means for determining whether the applicant possesses said predetermined applicant qualifications.

16. The system of claim 12, wherein said applicant evaluation system includes:
logic configured to receive information corresponding to predetermined applicant qualifications for the job; and
logic configured to determine whether the applicant possesses said predetermined applicant qualifications.

17. The system of claim 12, wherein said applicant evaluation system includes:
means for preventing the applicant from applying for the job via said Web site if the applicant's answer to the at least one test question is not correct.

18. The system of claim 12, wherein said applicant evaluation system includes:
logic configured to prevent the applicant from applying for the job via said Web site if the applicant's answer to the at least one test question is not correct.

19. The system of claim 12, wherein said applicant evaluation system includes:
a resume system configured to enable the applicant to submit a resume via the Web site if the applicant correctly answers the at least one test question.

20. The system of claim 12, wherein said applicant evaluation system includes:
means for enabling the applicant to submit a resume via the Web site if the applicant correctly answers the at least one test question.
